(19) United States
(12) Patent Application Publication
(10) Pub. No.: US 2012/0009815 A1
(43) Pub. Date: Jan. 12, 2012

(54) ADAPTER FOR ELECTRODE AND CONNECTOR ATTACHMENTS FOR A CYLINDRICAL GLASS FIBER FINE WIRE LEAD

(76) Inventors: Robert G. Walsh, Newport, OR (US); Jin Shimada, Grantsburg, WI (US)

(21) Appl. No.: 12/892,884

(22) Filed: Sep. 28, 2010

Related U.S. Application Data
(63) Continuation-in-part of application No. 12/887,388, filed on Sep. 21, 2010.
Application No. 12/887,388 is a continuation-in-part of application No. 12/590,851, filed on Nov. 12, 2009.
(60) Provisional application No. 61/277,528, filed on Sep. 28, 2009.

(51) Int. Cl. H01R 13/58

(52) U.S. Cl. 439/449

(57) ABSTRACT

A cardiac pacemaker or other CRT device has one or more fine wire leads to the heart. Formed of a glass, silica, sapphire or crystalline quartz fiber with a thin metal coating, a unipolar lead can have an outer diameter as small as about 300 microns or even smaller. The thin metal conductor poses unique challenges for attachment to standardized connectors as well as to stimulation electrodes. This invention describes structures and materials for creating robust and durable electrically conductive connections between the fine wire lead body and a proximal standardized connector and distal ring and tip electrodes by utilization of fine metal coils or mesh and electrically conductive adapters to aid in stabilizing the connections.

This application claims benefit from provisional application No. 61/277,528, filed Sep. 28, 2009, and is a continuation-in-part of application Ser. No. 12/887,388, filed Sep. 21, 2010, and also application Ser. No. 12/590,851, filed Nov. 12, 2009.

### BACKGROUND OF THE INVENTION

This invention concerns wiring for electrostimulation and sensing devices such as cardiac pacemakers, ICD and CRT devices, and neurostimulation devices, and in particular encompasses an improved implantable fine wire lead for such devices, a lead of very small diameter and capable of repeated cycles of bending without fatigue or failure. The term therapeutic electrostimulation device (or similar) as used herein is intended to refer to all such implantable stimulation and/or sensing devices that employ wire leads. A fine wire lead consists of several key components, including a lead body, a proximal connector, and one or more distal electrodes, which are affixed to the lead body. A key aspect to fabrication of a robust and durable glass or silica fiber-based fine wire lead is the manner in which the proximal connector is attached to the lead body, and the one or more electrodes to the distal end of the lead. This invention is directed towards defining a new adapter subassembly to enable a robust attachment of a connector and/or electrodes to a glass fiber fine wire lead body.

Definition of a robust and durable glass fiber fine wire pacing electrostimulation lead was the subject of copending U.S. application Ser. No. 12/156,129, filed on May 28, 2008 (Pub. No. 2009/0299446), and Ser. No. 12/590,51, filed Nov. 12, 2009, incorporated entirely herein by reference. In addition, copending application Ser. No. 12/660,344, filed Feb. 23, 2010, describes several forms of connections for such leads, and is also incorporated herein by reference.

This application describes further details and structure for connection of a fine wire lead with electrodes and connectors as depicted in provisional application Ser. No. 61/208,216 filed on Feb. 23, 2009, and also provisional application No. 61/277,052, filed Sep. 21, 2009, both provisional applications of which are incorporated herein by reference.

It is an object of the present invention described herein to address important structural details of the fine wire glass fiber leads described in the previous referenced patent applications. Those details refer to an adapter specifically designed to facilitate permanent stable attachment of standardized connectors, such as IS-1 and IS-4 connectors, as well as electrodes, to a glass fiber fine wire lead body. The adapter described herein serves to increase the strength of attachment of connectors and electrodes to the glass fiber fine wire lead body.

### SUMMARY OF THE INVENTION

As described in referenced application Ser. No. 12/156,129, a flexible and durable fine wire lead for implanting in the body, with connection to a pacemaker, ICD, CRT or other cardiac pulse generator, is formed from a drawn silica, glass, sapphire crystalline quartz fiber core with a conductive metal buffer cladding on the core. A polymer coating can be layered over the metal buffer cladding, which may be biocompatible and resistant to environmental stress cracking or other mechanism of degradation associated with exposure and flexure within a biological system. The outer diameter of the fine wire lead preferably is less than about 750 microns, and may be 200 microns or even as small as 50 microns. Metals employed in the buffer can include aluminum, gold, platinum, titanium, tantalum, silver, or others, as well as metal alloys of which MP35N, a nickel-cobalt based alloy is one example. In one example of metal cladding, a molten metal film, such as gold or silver is applied to the drawn silica, glass, sapphire crystalline quartz fiber core immediately upon drawing and providing a protective hermetic seal over the silica, glass, sapphire crystalline quartz fiber.

Alternatively, a thin film of polymer may be coated onto the fiber core immediately after drawing the core, with or without a hermetic carbon underlayment. In this case, a metallized conductor is deposited upon the polymer surface in a secondary process step.

If constructed in this fashion, metallization of the polymer surface can be accomplished via a continuous passage of polymer encapsulated silica or glass fiber through a deposition chamber during the metal deposition process. Such metal deposition may be carried out by vapor deposition, electroplating—especially upon an electrically conductive carbon surface, by coating with an electrically conductive ink, or by one of numerous other metal deposition processes known in the art. In the case of vapor deposition and related processes governed by line-of-sight considerations, one or more metal targets, that is, sources for vaporized metal, may be positioned within the metal deposition chamber in such a way as to insure overlap and complete 360 degree coverage of the fiber during the metal deposition process. Alternately, the fiber may be turned or rotated within the vapor deposition field to insure complete and uniform deposition.

Vapor deposition processes are typically carried out in an evacuated chamber at low atmospheric pressure (approximately 1.0×10⁻⁶ torr). After evacuation is attained, the chamber is backfilled with a plasma-forming gas, typically argon, to a pressure of 2.0×10⁻³ torr. Masking may be pre-applied to the carbon and/or polymer surface to enable a patterned coating of metal on the carbon and/or polymer surface. Such a pattern may be useful for creating two or more separate electrically conductive paths along the length of the fine wire lead, thus enabling fabrication of a bipolar or multipolar conductor upon a single fine wire lead. Inherent in the concept of a metallized fine wire lead is the ability to use more than one metal in the construction of such leads. For instance, an initial metal may be deposited on the basis of superior adhesion to the carbon and/or polymer underlayment. One or more additional metals or metal alloys could then be deposited on the first metal. Intent of the second metal would be to serve as the primary conductive material for carrying electrical current.

If more than one conductor is needed, multiple unipole fibers can be used, having one conductor per fiber. Alternatively, the silica or other type fiber can serve as a dielectric with a wire in the center of the fiber core as one conductor and the metallic buffer layer on the outside of the fiber core, providing fiber protection, and acting as the coaxial second conductor or ground return. The flexibility of a composite structure consisting of multiple unipolar fibers can be controlled by employing hollow fibers. A thin wall hollow fiber core will have greater flexural response for a given applied force, than a solid fiber core of the same material, and the same overall diameter.

The completed metallized lead body may be conveniently coated with a thin lubricious and protective polymeric material, such as Teflon, to provide necessary electrical insulation. Polyurethane or silicone may conveniently be used for such a jacketing material, providing biocompatibility and protection from the internal biochemical environment of the body. A composite polymeric coating can also be incorporated, consisting of a thin Teflon coating directly on the metallized glass fiber to provide insulation and lubricious protection from friction-related damage, along with an outer polymeric coating of polyurethane or silicone to provide additional electrical insulation as well as biocompatibility. As referenced earlier, a coaxial lead body design incorporating two independent electrical conductors may be constructed in which a metal conductor is embedded within the central glass or silica core, with the second conductor being applied to the carbon and/or polymer buffer residing on the outer surface of the glass or silica core.

In an additional embodiment of metal cladding for the glass fiber, temporary sealing materials may be applied to the glass fiber for protection. Subsequent steps carried out in a controlled environment facilitate removal of the temporary sealing materials, followed by resurfacing the fiber with metal or other material, such as polymer or carbon. Such steps enable controlled metal surfaces to be applied directly to the glass fiber, if so desired. Temporary sealing materials may consist of polymers, carbon, or metals, which are chosen for ease of removal. In the case of polymers, removal may be facilitated by dissolution in appropriate solvent, heat, alteration in pH or ionic strength, or other known means of control. Carbon and metals may be removed by chemical or electrochemical etching, heating, or other known means of control.

As indicated by the above, considerable flexibility exists for the construction of a robust and durable electrically conductive small diameter lead body for therapeutic electrostimulation. This flexibility is considered advantageous, as an additional set of requirements must be met for achieving a robust and stable attachment of proximal and distal terminals to the lead body.

The above-referenced application Ser. Nos. 12/156,129 and 12/660,344 describe connectors for fine wire leads of the type described above. In addition, other metal wire member configurations are applicable. One such configuration consists of multiple wire coils, with the coils all wrapping in the same direction, or one or more coils wrapping in opposite directions. In addition, one or more straight wire segments are envisioned. These wire segments can run roughly parallel with the glass fiber. Finally, various wire mesh member configurations are applicable. Any of various electrically conductive metals or metal alloys is suitable for use in fabricating the metallic wire or metallic mesh member components. These metals include but are not limited to silver, gold, platinum, aluminum, copper or MP35N. In addition, electrically conductive, non-metallic materials such as polymers may be used.

An adapter can be defined by which the connection between connectors or electrodes and glass fiber fine wire lead is facilitated, producing a robust physically stable electrical connection. The adapter is an electrically conductive metal or non-metal component sized to fit within an IS-1 or IS-4 connector, or within a ring electrode or terminal electrode. This adapter is fabricated to contain holes sized to receive terminal ends of one or more glass fiber fine wire lead filars, which incorporate wire coils or other electrically conductive wire or mesh components such as described in the preceding paragraphs. The adapters are bonded to the metal coils by way of electrically conductive adhesive, laser welding, crimping, or a combination of methods. In addition, for glass fibers that terminate within an adapter, the adapter may be arranged so that the fiber terminates within a tubular channel that runs the length of the adapter. With this arrangement, an alternative means of sealing the terminal end of the glass fiber within the adapter is via glass welding, in which a glass composition having a melting temperature lower than either the adapter or the glass fiber is introduced into the channel with heat to seal the channel with molten glass, which is then allowed to cool.

After an adapter is firmly affixed to a glass fiber, the adapter is then positioned within a IS-1 or IS-4 connector, or ring electrodes or terminal electrode. The manner of attachment of the adapter to the connector or electrode may be by electrically conductive adhesive, crimping, laser welding, or physical engagement facilitated by screw patterns or bayonet detents or other such means of material interference, as well as various combinations of these means.

Use of such adapters as described here is made possible by the small diameter glass fiber fine wire lead filars utilized for fabricating lead body. The small diameter filars make it possible for multiple electrically insulated filars to pass into and/or through the adapters envisioned herein, while allowing adapters to be sized for proper incorporation into IS-1 or IS-4 connectors, as well as ring and terminal electrodes.

Incorporation of adapters along with electrically conductive metallic or polymeric wire members such as the coils or mesh described above increase the intimacy of physical contact between the electrode or connector, with the glass fiber. The metal or electrically conductive polymeric coils and mesh configurations serve to protect the terminal of the glass fiber from potential crush damage resulting from crimping or other physical means used to stabilize the connection between adapter and glass fiber. The various metallic or electrically conductive wire configurations also serve as tension members. If tension is applied to the electrode or connector, the amount of force required to separate the adapter and associated electrode or connector from the glass fiber will be increased by the tensile loading of the metallic wire component or components.

Attachment of the electrically conductive polymer or metal adapter with the electrically conductive wire or mesh components as described in the preceding several paragraphs to the associated lead body is by way of one or more of the means as described earlier, namely by potting with electrically conductive adhesive or solder, or with molten metal or metal alloy or via laser welding, or physical compression or crimping. Alternatively, if the adapter is attached to the lead body prior to metallizing the lead body, then a conventional non-electrically conductive adhesive will suffice. Alternatively, the adapter may be bonded to the proximal end of the lead body by employing heat, via laser, ultrasonic welding, or other means of creating a robust bond between materials.

The outer surface contour of the electrically conductive polymer or metal adapter described above is designed so as to match an opposite pattern set in the pin or ring electrodes of a standardized connector for an electrostimulation or sensing device utilizing a IS-1 or IS-4 connector, or the ring or terminal electrodes at the distal end of the fine wire lead. In the case of the IS-1 or IS-4 connector, this pattern may be a screw or other detent means, exemplified by a bayonet style connection.

It is among the objects of the invention to improve the durability, lifetime flexibility and versatility of wire leads for pacemakers, ICDs, CRTs and other cardiac pulse generators, as well as electrostimulation or sensing leads for other therapeutic purposes within the body. This is effectuated in part by the invention described here, involving means and materials for achieving a robust and durable attachment of a standard connector to the terminus of a glass/silica lead body, as well as ring and tip electrodes to the distal terminus of a glass/silica lead body. These and other objects, advantages and features of the invention will be apparent from the following description of preferred embodiments, considered along with the accompanying drawings.

### DESCRIPTION OF THE DRAWINGS

FIG. 1 is a schematic drawing in perspective showing a wire coil serving as a tensile member in the connection of an electrode or connector to a fine wire lead body.

FIG. 2 is a schematic drawing in perspective showing a metallic wire mesh serving as a tensile member in the connection of an electrode or connector to a fine wire lead body.

FIG. 3 is a schematic drawing in perspective showing a metal coil serving as a tensile member overlaying a thin-walled electrically conducting metal tube, in the connection of an electrode or connector to a fine wire lead body.

FIGS. 4 and 4A are a schematic sectional view and a section view showing a dual connector at a termination of two conductive fibers, detailing how the connection is made.

FIGS. 5 and 5A are a schematic sectional view and an end view showing a pass through adapter for two conductive fibers, one of which is electrically connected to the adapter.

FIG. 6 is a schematic sectional view showing a four conductor lead and connector, at the termination of four conductive fibers.

### DESCRIPTION OF PREFERRED EMBODIMENTS

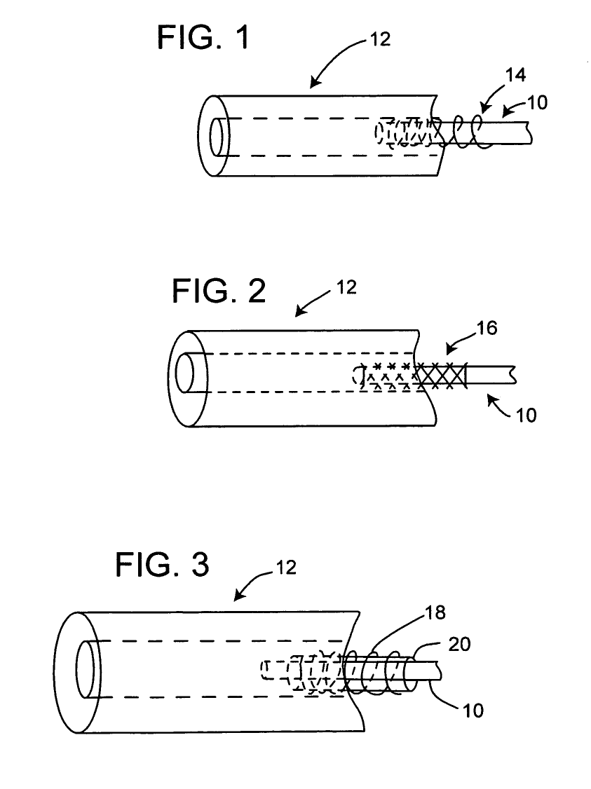

FIG. 1 shows a connection between the glass fiber lead, 10 (such as shown and described in referenced application Ser. No. 12/156,129), and an electrode or connecter body 12. A wire coil 14 is wrapped around the glass fiber to make a connection between the coating on the glass fiber, not shown, and the electrode or connector body 12. The wire coil 14 provides electrical connection and strain relief between the glass fiber lead 10 and the connection body 12. The wire coil 14 also acts to maintain the electrical connection when the joint between the glass fiber lead 10 and the electrode or connecter body 12 is flexed.

FIG. 2 shows a connection between the glass fiber lead 10 and the electrode or connecter body 12. A wire mesh 16 is wrapped around the glass fiber to make a connection between the coating on the glass fiber, not shown, and the electrode or connector body 12. The wire mesh 16 provides electrical connection and strain relief between the glass fiber lead 10 and the connection body 12. The wire mesh 16 also acts to maintain the electrical connection when the joint between the glass fiber lead 10 and the electrode or connecter body 12 is flexed.

FIG. 3 shows a connection between the glass fiber lead 10 and the electrode or connecter body 12. A metal coil 18 is wrapped around the glass fiber to make a connection between the coating on the glass fiber, not shown, and a thin-walled electrically conducting metal tube 20. The metal coil 18 provides electrical connection and strain relief between the glass fiber lead 10 and the connection body 12. The metal coil 18 also acts to maintain the electrical connection when the joint between the glass fiber lead 10 and the electrode or connecter body 12 is flexed.

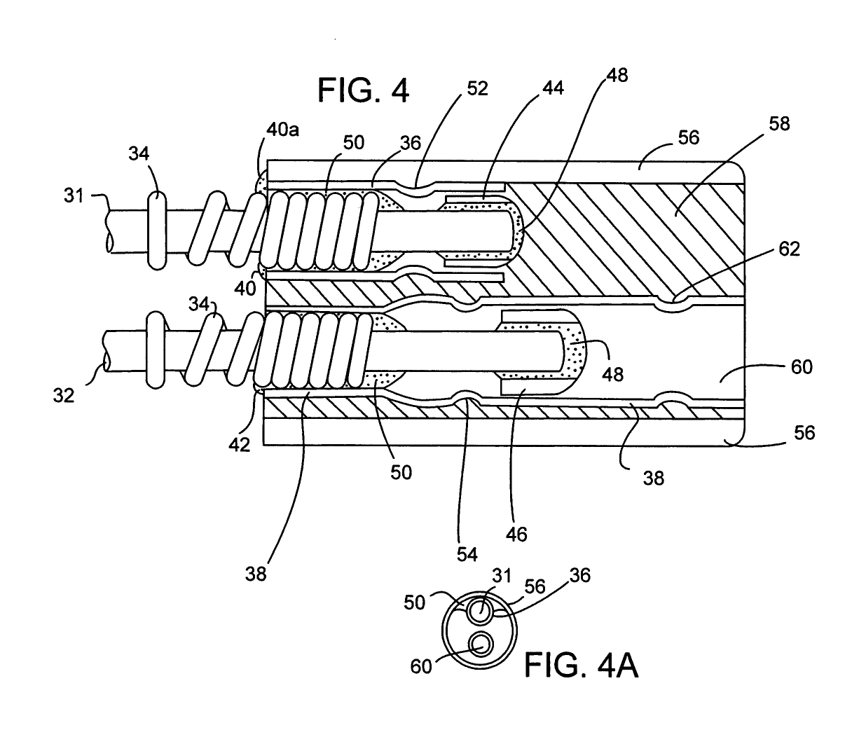

FIG. 4 shows a two pin conductor and termination for conductive fibers 31 and 32, and these can be as described in application Ser. No. 12/156,129. Metal coils 34 act as strain relief for the fibers 31 and 32. As illustrated, the metal coils 34 are anchored within respective generally cylindrical receiving bodies 36, 38 where the coils are wrapped closely around the metallized conductive fibers 31 and 32. The metal coils are welded to the receiving bodies 36, 38, the welds being indicated at 40, 40a and 42. At the end of each conductive fiber 31, 32 is a guide 44, 46, respectively, these guides being secured to the ends of the fibers by sealed glass 48. Each of the receiving bodies 36, 38 is filled with conductive adhesive as indicated at 50, thus assuring conductive contact among the conductive fiber, the coil and the receiving body. The guides 44 and 46 center the conductive fibers 31 and 32 into their corresponding receiver bodies. The receiving bodies preferably are swaged as shown at 52 and 54 to help retain the components in place in the receiving bodies. As illustrated, the entire volume around the conductive fiber within the receiving body need not be filled.

The illustrated connector includes an outer connector segment or connector body 56 which is adapted to fit with a standard connector (not shown) for an electrostimulation device or other electrical connector which can be implanted. Both the conductive fiber terminal assemblies are placed appropriately within the outer connector segment 56, such that the receiving body 36 is in contact with the connector segment 56 at an internal wall and the other receiving body 38 is at a prescribed position for receiving a connecting pin, as shown in both FIGS. 4 and 4A, and the components are potted in place with insulating material 58. This forms a connector device to be fit with a standard connector, by which the outer surface of the connector segment or body 56 makes contact with one terminal and a pin connector socket 60 is positioned to receive a pin as a second terminal. This is an end that for reference purposes can be called a distal end. As illustrated, the receiving body 38 can have a swage at 62, forming an inner annular ridge, for gripping a pin connector.

Note that the weld 42 on the receiving body 38 can be made before assembly into the outer connector segment 56, as can a portion of the weld 40. The weld 40 is then extended after insertion of the receiving body 36 into the outer body 56, to secure the receiving body 36 and conductive fiber assembly to the outer shell or body or outer connector segment 56.

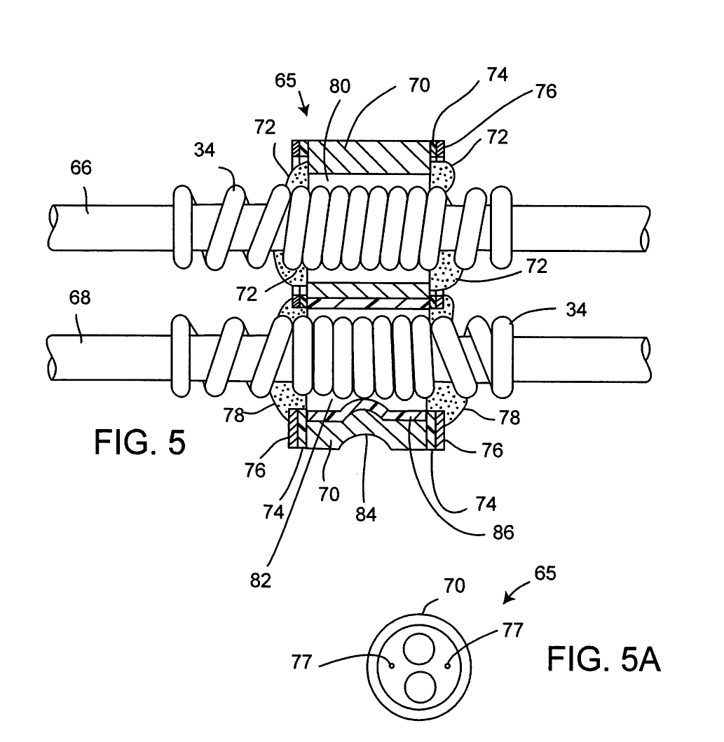

FIGS. 5 and 5A show a pass through adapter 65 which utilizes some of the connector principles described relative to FIGS. 4 and 4A. This pass through adapter is conductively connected to only one conductive silica fiber, the upper fiber 66 as seen in FIGS. 5 and 5A. Since only the conductive fiber 66 is to be electrically connected to the outer ring 70 of the adapter, provision is made to connect the fiber 66 and a strain relieving coil 34 secured around the fiber to the metal outer shell or ring 70. This is shown in the upper portion of FIG. 5, where the strain relieving coil 34 wraps closely around the conductive fiber 66 and is welded at 72 to the body 70 of the adapter, at both left and right as seen in FIG. 5. The lower conductive fiber 68, however, is not grounded to the adapter body 70. For this purpose a pair of discs are included, one insulated and one metal and conductive. The discs are shown at both left and right of the adapter, at 74 (insulative) and at 76 (conductive). These discs are shaped generally as defined by the entire outer ring 70 as seen in FIG. 5A, with upper and lower holes for the fiber assemblies. They may be retained by fastener pins 77 (FIG. 5A), provided they are non-conductive, or by adhesives. The upper holes in the insulative and conductive discs 74 and 76 are larger, as can be seen in the upper part of FIG. 5A, so as to provide room for welding of the coil 34 to the metal conductive adapter body 70. The welds 72 do not touch the outer conductive disc layer 76.

However, in the lower part of FIG. 5 the welds 78 connect the coil 34 to the outer conductive disc 76 (at both left and right), but not to the conductive body 70 of the adapter. Here, the holes through the discs 74 and 76 are smaller so that the weld can engage with the outer disc layer 76. As shown in the drawing, the conductive body 70 is spaced away from the welds. Thus, the upper conductive fiber 66 is firmly grounded to the adapter body or outer ring 70, while the lower conductive fiber 68 is not.

Both openings through the conductive metal adapter body 70 are filled with adhesive. For the upper fiber 66, this is a conductive adhesive 80, while the lower assembly has a non-conductive adhesive 82. This adhesive 82 serves the insulation function described above. Note also that the assembly can include a mechanical swage 84 (which can be annular, but is not shown at the top of the drawing). To prevent this swage from contacting the coil 34 on the conductive fiber 68, an insulative sleeve 86 preferably is included, lining the hole in which the lower assembly is made. The device of FIG. 5 retains the fiber lead 68 while allowing electrical connection to the fiber lead 66. The fiber lead 68 may be connected to an electrode or other connection distally or proximally of the pass through connector 65. Note also, the non-connected fiber lead 68 could terminate at the device 65, ending therein, in a case where retention of the pair together is desired.

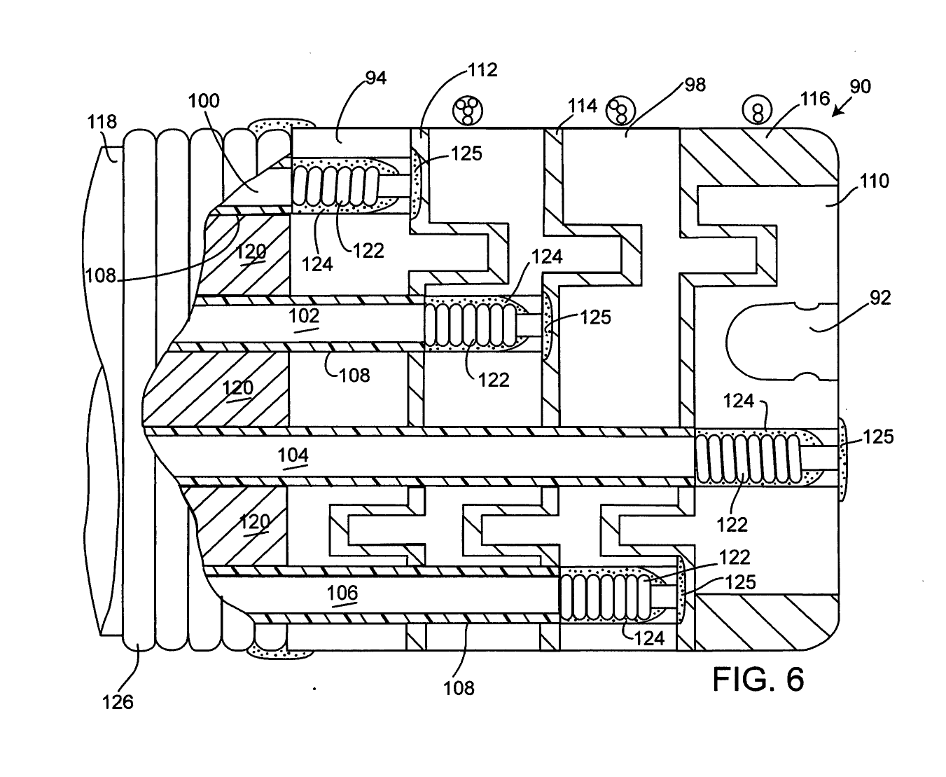

FIG. 6 shows a four conductor lead end connector 90 schematically, in cross section. This connector has a pin connector 92 at its end and three separate connection rings 94, 96 and 98 at its outer surface, each insulated from the others and from the pin connector 92. Each of four conductive fiber leads 100, 102, 104 and 106 is covered with an insulating tube 108 up to the point where it makes electrical connection with the respective conductive ring 94, 96, 98 or, in the case of the pin connector, 110. Insulation between adjacent conductive portions is shown at 112, 114 and 116. The positions of the fibers 100, 102, 104 and 106, although appearing to be within one plane within the cylindrically shaped connector body 90, actually are preferably rotated relative to one another, as schematically indicated at the top of the drawing.

Each conductive fiber (100, 102, 104, 106) enters from a bundle or tubular pipe 118, within which they may be held in respective positions by insulating adhesive material 120, and extends into the conductive portion within which it is electrically connected. As seen in the drawing, the insulative sleeve or tube 108 insulates the conductive fiber until the point where it enters the conductor, such as 94 or 96, to which it is connected. Coils 122 can be connected around each fiber end, primarily for the purpose of making a good electrical connection in this case. Conductive adhesive 124 fills space between the coil and the metal of the bore within which the conductive fiber end resides, providing good electrical contact between the fiber and the metal bore and between the coil and the metal bore.

FIG. 6 shows a weld 125 at the end of the fiber lead 104, and this can be a glass/metal weld and can further connect the fiber lead to the metal that surrounds the pin connector 92. Other welds can be used at the ends of the other fiber leads, as indicated.

Note that the insulating tube or sleeves 108 can provide mechanical strength as well as insulation for each of the conductive fibers. FIG. 6 also shows a large strain relief coil 126 which can be firmly secured to the connector body and can provide strain relief for a distance away from the connector.

The strain relief referred to herein, achieved by the coils as discussed above, is a function of allowing some bending of the conductive fibers but restricting that bending to a uniform bending, without any severe bend portions. These strain relieving coils, applied to very fine conductive glass fibers to provide strain relief by preventing sharp bending, such as implanted as electrostimulation leads, in the environment of extremely high cycles of bending, is an important feature of the invention.

The above described preferred embodiments are intended to illustrate the principles of the invention, but not to limit its scope. Other embodiments and variations to these preferred embodiments will be apparent to those skilled in the art and may be made without departing from the spirit and scope of the invention as defined in the following claims.

We claim:

1. An end connector for a plurality of conductive metal coated glass/silica fiber leads, comprising:
at least two conductive metal coated glass/silica fiber leads having ends,
on an end portion of each fiber lead near the end of the lead, a metal coil closely surrounding the lead,
a conductive metal, generally cylindrical receiving body surrounding the end portion of each fiber lead and surrounding a portion of the metal coil,
conductive adhesive material within each receiving body securing electrical connection among the fiber lead, the metal coil and the receiving body, and
a generally cylindrical connector body into which the receiving bodies and fiber leads extend, the connector body having an exterior conductor to which one of the receiving bodies is electrically connected to provide a first connector terminal, and the connector body having a second exterior connector terminal, the second connector terminal comprising a conductor electrically connected to another of the receiving bodies and insulated from the first connector terminal.

2. The end connector of claim 1, wherein the conductor of the second connector terminal comprises a pin connector socket extending generally parallel to the axis of the generally cylindrical connector body and positioned at an end of the connector body.

3. The end connector of claim 2, wherein the pin connector socket comprises a distal end of said other receiving body.

4. The end connector of claim 1, wherein each fiber lead has a guide secured to its end, centering the end of the fiber within the receiving body.

5. The end connector of claim 1, wherein each metal coil extends outward of the receiving body and of the connector body, such that a proximal portion of the metal coil provides strain relief for the fiber lead just outside the connector body, preventing sharp bending.

6. The end connector of claim 1, wherein the end connector comprises four connector terminals, said first connector terminal including a metal ring exposed at exterior of the connector body and said second connector terminal comprising a pin connector at a distal end of the metal body, and third and fourth connector terminals comprising further metal rings exposed at exterior of the connector body, and all connector terminals being insulated from the others.

7. The end connector of claim 1, wherein each glass/silica fiber lead has an outer diameter less than about 750 microns.

8. The end connector of claim 7, wherein each glass/silica fiber lead has an outer diameter less than about 200 microns.

9. The end connector of claim 7, wherein each glass/silica fiber lead has an outer diameter less than about 50 microns.
